(19) United States
(12) Patent Application Publication
(10) Pub. No.: US 2016/0350002 A1
(43) Pub. Date: Dec. 1, 2016

(54) Memory device specific self refresh entry and exit

(71) Applicant: Intel Corporation, Santa Clara, CA (US)

(72) Inventors: George Vergis, Portland, OR (US); Kuljit S. Bains, Olympia, WA (US); James A. McCall, Portland, OR (US); Murugasamy K. Nachimuthu, Beaverton, OR (US); Mohan J. Kumar, Aloha, OR (US)

(21) Appl. No.: 14/998,058

(22) Filed: Dec. 26, 2015

Related U.S. Application Data
(60) Provisional application No. 62/168,513, filed on May 29, 2015.

(51) Int. Cl. G06F 3/06

(52) U.S. Cl. CPC G06F 3/0605; G06F 3/0634; G06F 3/0683

(57) ABSTRACT

A system enables memory device specific self-refresh entry and exit commands. When memory devices on a shared control bus (such as all memory devices in a rank) are in self-refresh, a memory controller can issue a device specific command with a self-refresh exit command and a unique memory device identifier to the memory device. The controller sends the command over the shared control bus, and only the selected, identified memory device will exit self-refresh while the other devices will ignore the command and remain in self-refresh. The controller can then execute data access over a shared data bus with the specific memory device while the other memory devices are in self-refresh.

### RELATED APPLICATIONS

The present patent application is a nonprovisional based on, and claims the benefit of priority of, U.S. Provisional Patent Application No. 62/168,513, filed May 29, 2015. The provisional application is hereby incorporated by reference.

The present patent application is related to the following patent application: patent application No. TBD [P84940], entitled “POWER PROTECTED MEMORY WITH CENTRALIZED STORAGE,” filed concurrently herewith.

### FIELD

Descriptions herein are generally related to memory subsystems, and more specific descriptions are related to memory device self-refresh commands.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright© 2015, Intel Corporation, All Rights Reserved.

### BACKGROUND

Memory subsystems store code and data for use by the processor to execute the functions of a computing device. Memory subsystems are traditionally composed of volatile memory resources, which are memory devices whose state is indefinite or indeterminate if power is interrupted to the device. Thus, volatile memory is contrasted with persistent or nonvolatile storage, which has a determinate state even if power is interrupted to the device. The storage technology used to implement the memory device determines if it is volatile or nonvolatile. Typically volatile memory resources have faster access times, and denser (bits per unit area) capacities. While there are emerging technologies that may eventually provide persistent storage having capacities and access speeds comparable with current volatile memory, the cost and familiarity of current volatile memories are very attractive features.

The primary downside of volatile memory is that its data is lost when power is interrupted. There are systems that provide battery-backed memory to continue to refresh the volatile memory from battery power to prevent it from losing state if primary power is interrupted. There are also systems in which memory devices are placed on one side of a DIMM (dual inline memory module), and persistent storage is placed on the other side of the DIMM. The system can be powered by super capacitor or battery that holds enough charge to enable the system to transfer the contents of the volatile memory devices to the persistent storage device(s) if power is interrupted to the memory subsystem. While such systems can prevent or at least reduce loss of data in the event of a loss of power, they take up a lot of system space, and cut the DIMM capacity in half. Thus, such systems are impractical in computing devices with more stringent space constraints. Additionally, lost memory capacity results in either having less memory, or costly solutions to add more hardware.

Currently available memory protection includes Type 1 NVDIMM (nonvolatile DIMM), which is also referred to in industry as NVDIMM-n. Such systems are energy backed byte accessible persistent memory. Traditional designs contain DRAM (dynamic random access memory) devices on one side of the DIMM and one or more NAND flash devices on the other side of the DIMM. Such NVDIMMs are attached to a super capacitor through a pigtail connector, and the computing platform supplies 12V to the super capacitor to charge it during normal operation. When the platform power goes down, the capacitor supplies power to the DIMM and the DIMM controller to allow it to save the DRAM contents to the NAND device on the back of the DIMM. In a traditional system, each super capacitor takes one SATA (serial advanced technology attachment) drive bay of real estate.

Traditionally, RDIMMs (registered DIMMs) cannot be used to implement an NVDIMM solution, because there is no buffer between the devices and the nonvolatile storage on the data bus to steer the data between the host and the storage. Thus, more expensive LRDIMMs (load reduced DIMMs) are traditionally used for NVDIMM, which have buffers on the data bus. On a typical DRAM DIMM the devices are organized as ranks, where each rank is comprised of multiple DRAMs. The self-refresh exit command or signal (CKE) is common across all DRAMs in the rank; thus, all devices respond to the command simultaneously. Given this simultaneous response, accessing data from an individual DRAM over a common data bus is not traditionally possible, seeing that the DRAMs contend for the data bus. Thus, when DRAMs share a common command/address (C/A) or control bus, they cannot also share a data bus. DRAMs that share a C/A or control bus traditionally have dedicated data paths to the host memory controller. However, on an NVDIMM, a dedicated data bus or dedicated C/A bus are not practical due to pin count and power constraints.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system with a controller that can execute device specific self-refresh commands.

FIG. 2 is a block diagram of an embodiment of a DIMM (dual inline memory module) for a power protected memory system with centralized storage in which data is transferred via device specific self-refresh commands.

FIG. 3 is a block diagram of an embodiment of a DIMM (dual inline memory module) for a power protected memory system with centralized storage in which data is transferred via device specific self-refresh commands.

FIG. 4 is a block diagram of an embodiment of a power protected memory system with consolidated storage not on the NVDIMM (nonvolatile DIMM) in which a controller uses device specific self-refresh commands.

FIG. 5 is a block diagram of an embodiment of a power protected memory system with centralized storage that uses device specific self-refresh commands to perform data transfer.

FIG. 6 is a flow diagram of an embodiment of a process for using device specific self-refresh commands for nonvolatile backup of volatile memory.

FIG. 7A is a block diagram of an embodiment of a register that enables a per device self-refresh mode.

FIG. 7B is a block diagram of an embodiment of a register that stores a per device identifier for per device self-refresh mode.

FIG. 8 is a timing diagram of an embodiment of per device backup to persistent storage.

FIG. 9 is a block diagram of an embodiment of a system in which per memory device self-refresh commands can be implemented.

FIG. 10 is a block diagram of an embodiment of a computing system in which a device specific self-refresh command can be implemented.

FIG. 11 is a block diagram of an embodiment of a mobile device in which a device specific self-refresh command can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a system enables memory device specific self-refresh entry and exit commands. When all memory devices on a shared control bus (such as all memory devices in a rank) that also share a data bus are in self-refresh, a memory controller can issue a device specific command with a self-refresh exit command and a unique memory device identifier to the memory device. The controller sends the command over the shared control bus, but only the selected, identified memory device will exit self-refresh while the other devices will ignore the command and remain in self-refresh. The controller can then execute data access over the shared data bus with the specific memory device while the other memory devices are in self-refresh.

Reference to memory devices can apply to different memory types. Memory devices generally refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), and/or others, and technologies based on derivatives or extensions of such specifications.

Descriptions herein referring to a “DRAM” can apply to any memory device that allows random access. The memory device or DRAM can refer to the die itself and/or to a packaged memory product.

A system that enables device specific self-refresh exit (or per device exit from self-refresh) provides more possibilities for NVDIMM (nonvolatile dual inline memory module) implementations. While descriptions below provide examples with respect to DIMMs, it will be understood that similar functionality can be implemented in whatever type of system includes memory devices that share a control bus and a data bus. Thus, the use of a specific “memory module” is not necessary. In one embodiment, device specific exit from self-refresh enables a controller to cause a single DRAM to exit from self-refresh at a time from a common control bus.

Traditional DIMMs include RDIMMs (registered DIMMs) and LRDIMMs (load reduced DIMMs) to try to reduce the loading of the DIMM on a computing platform. The reduced loading can improve signal integrity of memory access and enable higher bandwidth transfers. On an LRDIMM, the data bus and control bus (e.g., command/address (C/A) signal lines) are fully buffered, where the buffers re-time and re-drive the memory bus to and from the host (e.g., an associated memory controller). The buffers isolate the internal buses of the memory device from the host. On an RDIMM, the data bus connects directly to the host memory controller. The control bus (e.g., the C/A bus) is re-timed and re-driven. Thus, the inputs are considered to be registered on the clock edge. In place of a data buffer, RDIMMs traditionally use passive multiplexers to isolate the internal bus on the memory devices from the host controller.

In contrast to traditional systems, with per device self-refresh commands, an RDIMM can be used for an NVDIMM implementation. Traditional DIMM implementations have a 72-pin data bus interface, which causes too much loading to implement an NVDIMM. LRDIMMs are traditionally used because they buffer the bus. But by allowing only a selected DRAM or DRAMs to exit self-refresh while the other DRAMs remain in self-refresh, the interface can be serialized and the loading significantly reduced on the host. Thus, in one embodiment, an RDIMM can be employed as an NVDIMM.

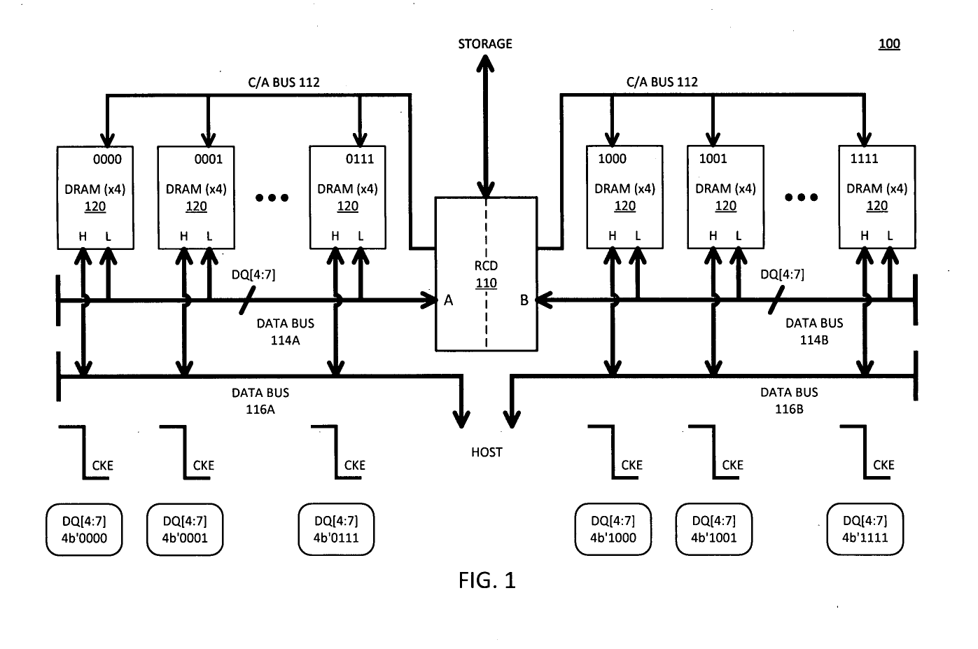

FIG. 1 is a block diagram of an embodiment of a system with a controller that can execute device specific self-refresh commands. System 100 illustrates one embodiment of a system with memory devices 120 that share a control bus (C/A (command/address) bus 112) and a data bus (data bus 114A shared among DRAMs 120 with addresses 0000:0111 and data bus 114B shared among DRAMs 120 with addresses 1000:1111). Memory devices 120 can be individually accessed with device specific self-refresh commands; thus, device specific self-refresh commands can be applied to individual DRAMs 120 and/or with groups of selected DRAMs 120. System 100 illustrates sixteen memory devices (0000:0111 on port A, and 1000:1111 on port B). In one embodiment, DRAMs 120 represent memory devices on a DIMM.

It will be understood that different implementations can have different numbers of memory devices (either more or fewer). In one embodiment, each memory device 120 of system 100 has a unique identifier (ID) or device ID (DID). In one embodiment, each memory device 120 coupled to a separate data bus has a unique DID, which can be the same as a DID of another memory device on a parallel or different memory bus. For example, memory devices 120 coupled to port B of RCD 110, coupled to data bus 114B could be numbered from 0000:0111, similar to memory devices 120 of data bus 114A. As long as each memory device 120 on a common command and address bus or control line, and data bus has a unique ID assigned to it, the system can generate device specific self-refresh commands. With the 4 bit IDs illustrated, there are 16 possible unique IDs, which is one example, and more or fewer bits can be used to address each device, depending on the implementation.

RCD 110 represents a controller for system 100. It will be understood that the controller represented by RCD 110 is different from a host controller or memory controller (not specifically shown) of a computing device in which system 100 is incorporated. Likewise, the controller of RCD 110 is different from an on-chip or on-die controller that is included on the memory devices 120. In one embodiment, RCD 110 is a registered clock driver (which can also be referred to as a registering clock driver). The registered clock driver receives information from the host (such as a memory controller) and buffers the signals from the host to the various memory devices 120. If all memory devices 120 were directly connected to the host, the loading on the signal lines would degrade high speed signaling capability. By buffering the input signals from the host, the host only sees the load of RCD 110, which can then control the timing and signaling to the memory devices 120. In one embodiment, RCD 110 is a controller on a DIMM to control signaling to the various memory devices.

RCD 110 includes interface circuitry to couple to the host and to memory devices 120. While not shown in specific detail, the hardware interface can include drivers, impedance termination circuitry, and logic to control operation of the drivers and impedance termination. The interfaces can include circuitry such as interfaces described below with respect to an interface between a memory device and a memory controller. The interface circuitry provides interfaces to the various buses described with respect to system 100.

In one embodiment, RCD 110 has independent data ports A and B. For example, the memory devices may access independent channels, enabling the parallel communication of data on two different data buses 114. In one embodiment, all memory devices 120 in system 100 share the same data bus 114. In one embodiment, memory devices 120 are coupled to parallel data buses for purposes of signaling and loading. For example, a first data bus (e.g., data bus 114) can be the data bus coupled to RCD 110, which provides data from the host. A second data bus (e.g., data bus 116) can be the data bus coupled to a storage device. In one embodiment, the second data bus can be coupled directly to the host. Where data bus 116 is coupled directly to the host, it can provide reduced loading via multiplexers or other circuitry that enables serialization of the data from memory devices 120.

Memory devices 120 are illustrated having an H port coupled to the RCD, which can be a command and/or control driver. Memory devices 120 are also illustrated having an L port coupled for device specific control. The device specific control can serialize the data output, seeing that memory devices 120 can be activated one at a time. In one embodiment, memory devices 120 are activated one at a time by RCD 110. In one embodiment, RCD 110 activates one memory device 120 per shared control bus and data bus. Thus, to the extent system 100 includes multiple different data buses, multiple memory devices 120 can be activated, with an individual memory device 120 activated on each data bus.

In one embodiment, memory devices 120 includes a register (not specifically shown in system 100) to store the DID. For example, memory devices 120 can store DID information in an MPR (multipurpose register), mode register, or other register. In one embodiment, system 100 assigns a unique ID to each memory device during initialization using PDA (Per DRAM address) mode. In one embodiment, a BIOS (basic input/output system) generates and assigns unique IDs during system initialization. In one embodiment, each memory device 120 of system 100 can be configured and enabled for a new mode, which is the device specific self-refresh control mode. In such a mode, each memory device 120 can match its unique DID to respond to self-refresh commands (such as a self-refresh exit signal (CKE)). In one embodiment, memory devices 120 are configured by the associated host via a mode register for a device specific self-refresh command mode. In such a mode, only the memory device with matching ID will exit self-refresh, and the others will ignore the command and remain in self-refresh.

For example, consider that all memory devices 120 have been placed in self-refresh. RCD 110 can send a device specific SRX (self-refresh exit) command to DRAM 0000. Because C/A bus 112 is shared among memory devices 120, all memory devices sharing the bus will receive the SRX command. However, if they are enabled for device specific self-refresh commands, DRAMs 0001:1111 will ignore the command and remain in self-refresh, while only DRAM 0000 awakes from refresh. In one embodiment, C/A bus 112 is a single bus shared among all memory devices 120. In one embodiment, C/A bus 112 is separated as C/A bus 112A and C/A bus 112B corresponding to the separation of data bus 114. In one embodiment, C/A bus 112 can be a single bus whether data bus 114 is a single bus or separated into A and B ports.

In one embodiment, system 100 includes a common bidirectional 4-bit source synchronous data bus 114 (4 bits of data and matched strobe pair) from RCD 110 to memory devices 120. In one embodiment, system 100 includes multiple common buses to mitigate loading, such as data bus 114A and data bus 114B. System 100 specifically illustrates two buses (A and B) as an example. In one embodiment, data buses 114 are terminated at either end of the bus segment to avoid signal reflections. In one embodiment, RCD 110 is a controller and a command issuer. In one embodiment, RCD 110 functions as a C/A register. RCD 110 can forward commands from the host. In one embodiment, RCD 110 can initiate sending of device specific self-refresh commands, without a direct command from the host.

In one embodiment, RCD 110 will drive a unique 4 bit ID on C/A bus 112, while issuing a self-refresh command. In one embodiment, RCD 110 will drive a unique 4 bit ID on data bus 114, while issuing a self-refresh command on C/A bus 112. It will be understood that for data transfer to/from a nonvolatile memory (e.g., “storage” as illustrated in system 100), the self-refresh command is a self-refresh exit to select a memory device for data access. Once the transfer is complete, RCD 110 can place the memory device back into self-refresh with a device specific self-refresh enter command (e.g., a self-refresh command with a DID). RCD 110 could alternatively place the memory device back into self-refresh with a general self-refresh enter command. In one embodiment, RCD 110 can retrieve the data to transfer to/from the nonvolatile storage for each volatile memory device 120 in succession by applying unique IDs while placing the memory devices with completed transactions back into self-refresh.

In one embodiment, when system 100 is implemented as an NVDIMM, the operation flow can occur in accordance with the following. In one embodiment, during platform initialization, BIOS code programs the unique DIDs into each memory device using PDA (per DRAM addressability) mode commands. In one embodiment, to save data in response to detection of a power supply interruption, a memory controller (e.g., such an integrated memory controller (iMC)) of the host can issue commands to cause the memory devices to flush I/O buffers into memory arrays of the memory device, and place all memory devices in self-refresh. An iMC is a memory controller that is integrated onto the same substrate as the host processor or CPU (central processing unit).

In one embodiment, RCD 110 selects an LDQ nibble of the memory device (e.g., a segment of data or DQ bits via the L port), and programs a per device self-refresh exit mode (which can be via command, via a mode register, or via other operation). In one embodiment, RCD 110 issues a self-refresh exit command with a target DID on the LDQ nibble. Only the memory device with the matching DID will exit self-refresh, and all other memory devices 120 on the same data bus 114 with remain in self-refresh. In one embodiment, RCD 110 issues read and/or write commands to the selected memory device 120 to execute the data transfer for the data access operation. In response to a detection of power failure, the operations will primarily be read operations to read data from memory devices 120 to write to storage. When power is restored, the operations may be primarily write operations to restore the data from storage to memory devices 120.

In one embodiment, when the read or write transaction(s) are complete or finished, RCD 110 places the selected memory device 120 back into self-refresh. RCD 110 can then repeat the process of selecting a specific memory device, causing it to exit from self-refresh, executing the data access operation(s), and putting the device back into self-refresh, until all data transfers are complete. Thus, the per device self-refresh control can enable NVDIMMs with native interfaces to have a pin, component count, and power efficient multi-drop bus to move data from memory devices 120 to nonvolatile memory or nonvolatile storage.

Traditionally only LRDIMMs can be used as NVDIMMs. DIMMs presently are designed with a 72 bit data bus. Connecting the 72 bit data bus to a single nonvolatile storage interface is very inefficient and not practical due to pin count and loading. Thus, RDIMMs, which are not buffered, are impractical for traditional NVDIMM implementations. In contrast, in an LRDIMM the bus goes through the buffer, and the buffer can gate the data transfer to and/or from the host, which reduces loading, and can enable a narrower interface. Alternatively, the buffer can serialize the data transfer or I/O (input/output) into an independent bus connecting to a nonvolatile storage subsystem. Traditionally, during a power failure the 72 bit memory data bus is isolated from the system and connected to the nonvolatile storage (which can also be referred to as a nonvolatile memory (NVM)) subsystem.

In accordance with system 100, RDIMMs can provide a sub-bus such as data buses 114 and 116 where the devices can be addressed and accessed serially via device specific commands. The ability to selectively, device by device, cause memory devices 120 to enter and exit self-refresh allows the use of a serialized bus interface to storage from memory devices 120. Such a sub-bus is more pin efficient than trying to route each bit of the 72 bit data bus. Once the data is serialized, the data transfer can be transferred to nonvolatile storage, with functionality that is not generally distinguishable between an RDIMM or LRDIMM NVDIMM implementation.

Thus, as described herein, NVDIMMs can have a shared local data bus, where the data is accessed from each memory device (e.g., DRAM (dynamic random access memory)) individually. Addressing each device in sequence serializes the data on the data bus, which allows the efficient storing and restoring the contents of the volatile memory devices to/from the nonvolatile storage media. In one embodiment, device specific self-refresh control allows individual control over memory devices on a DIMM, which allows data access operations (e.g., read, write) to be targeted to a single memory device, while keeping the other memory devices in a self-refresh state to avoid data contention on the data bus. Additionally, the fact that all memory devices are in a low power state except the one or ones transferring data to/from the nonvolatile storage, such an implementation improves power savings.

In one embodiment, the device specific self-refresh control leverages existing PDA mode commands available in certain memory technology implementations. Such PDA modes are not necessarily required. The memory devices can be addressed in another way, such as preconfiguring the devices or setting a DID based on location in the memory module. In one embodiment, the computing platform (e.g., via BIOS or other control) can assign a unique identifier (e.g., a unique device identifier or DID) to each memory device. In one embodiment, self-refresh commands (e.g., SRE (self-refresh entry), SRX (self-refresh exit)) can be issued with a specific DID. In one embodiment, such commands can be considered PDA SR (per DRAM addressability self-refresh) commands. When the memory devices are configured in PDA mode, they will only execute on commands with their specific DID. Thus, only the memory device that matches the unique DID will respond to the self-refresh entry/exit command/signal, and the other devices will remain in self-refresh. With a single device per bus active, the controller can control the exchange of data with nonvolatile storage while avoiding contention on the shared data bus.

On a typical DRAM DIMM implementation of system 100, memory devices 120 would be organized as ranks, where each rank includes multiple DRAMs 120. Traditionally, each rank shares a control bus and a data bus. Thus, self-refresh exit commands or signals (e.g., CKE) are common across all the memory devices 120 in the rank, and all memory devices 120 will respond to the command simultaneously. Given this simultaneous response, accessing data from an individual DRAM over a common data bus is not traditionally possible due to bus contention. However, in accordance with system 100, memory devices 120 can be organized in a traditional implementation, but the individual DRAMs can be accessed one at a time without bus contention.

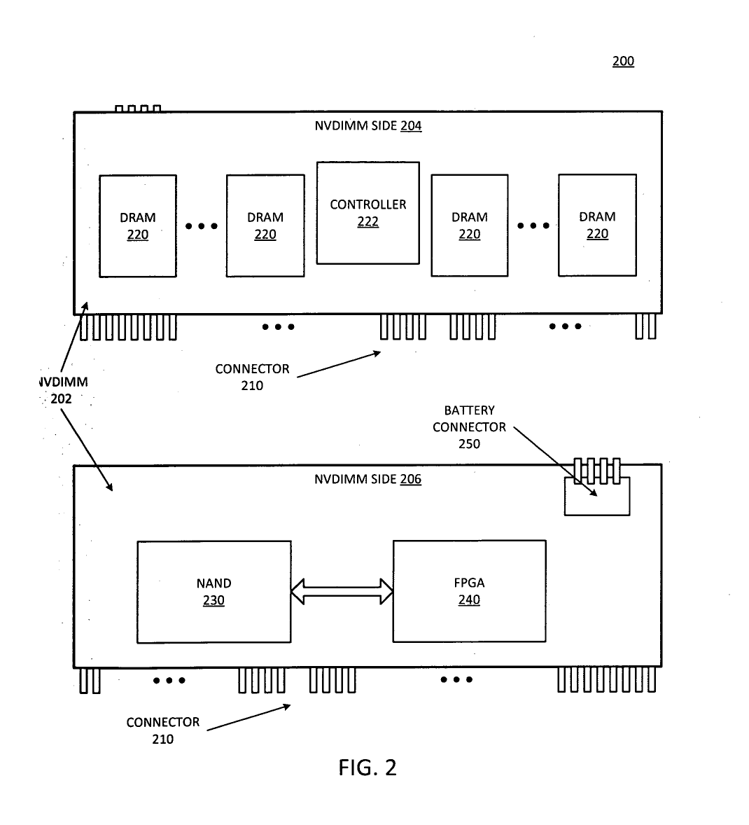

FIG. 2 is a block diagram of an embodiment of a DIMM (dual inline memory module) for a power protected memory system with centralized storage in which data is transferred via device specific self-refresh commands. System 200 provides one example of an NVDIMM in accordance with an embodiment of system 100. In one embodiment, NVDIMM side 204 is a “front” side of NVDIMM 202, and NVDIMM side 206 is a “back” side of NVDIMM 202. In one embodiment, front side 204 includes multiple DRAM devices 220. It will be understood that the layout is for illustration only, and is not necessarily representative of an actual implementation. In one embodiment, back side 206 includes NAND storage device 230 to provide nonvolatile storage for backing up DRAMs 220, and FPGA (field programmable gate array) 240 to control transfer of data for backup to nonvolatile storage 230. In one embodiment, NVDIMM 202 is an RLDIMM (buffers not specifically illustrated). In one embodiment NVDIMM 202 is an RDIMM.

In one embodiment, NVDIMM 202 includes controller 222, which can be or include an RCD in accordance with RCD 110 of system 100. In one embodiment, FPGA 240 can be programmed to perform at least some of the functions of an RCD in accordance with system 100. FPGA 240 primarily implements data transfer logic for NVDIMM 202. In one embodiment, with an RDIMM, the transfer logic can serially transfer the contents of DRAMs 220 to backup NAND 230. Back side 206 of NVDIMM 202 illustrates battery connector 250 to interface with a super capacitor or battery to remain powered when power supply power is interrupted. The external supply can provide sufficient time to transfer data from DRAMs 220 to NAND 230 and/or to maintain the DRAMs powered in self-refresh when power to NVDIMM 202 is interrupted.

NVDIMM 202 includes connector 210 to couple to a host. For example, NVDIMM 202 can interface through a memory expansion slot that matches with connector 210. Connector 210 can have specific spacing of pins to match with an interface on a computing device motherboard. While not specifically shown, it will be understood that NVDIMM 202 includes signal lines routed from connector 210 to DRAMs 220 and controller 222 to interconnect controller 222 and DRAMs 220 to the host.

NVDIMM 202 can include multiple parallel data buses as illustrated in system 100. DRAMs 220 share a control line and data bus. DRAMs 220 couple to NAND 230 via at least one data bus, to enable transfer of memory contents. Controller 222 couples to the control line and shared data bus. In one embodiment, controller 222 and/or FPGA 240 includes logic or circuitry to send device specific self-refresh commands, such as an SRX command, including a command and a device specific identifier. The device specific self-refresh command causes only a specified DRAM 220 to respond to the command, while the other DRAMs ignore the command. System 200 specifically illustrates an embodiment wherein nonvolatile storage is disposed on or located directly on the NVDIMM. In response to detection of power interruption, in one embodiment, controller 222 serially selects DRAMs 220 in turn to transfer data to NAND 230. Controller 222 can place DRAMs 220 in self-refresh and individually wake them from refresh in turn with device specific refresh commands.

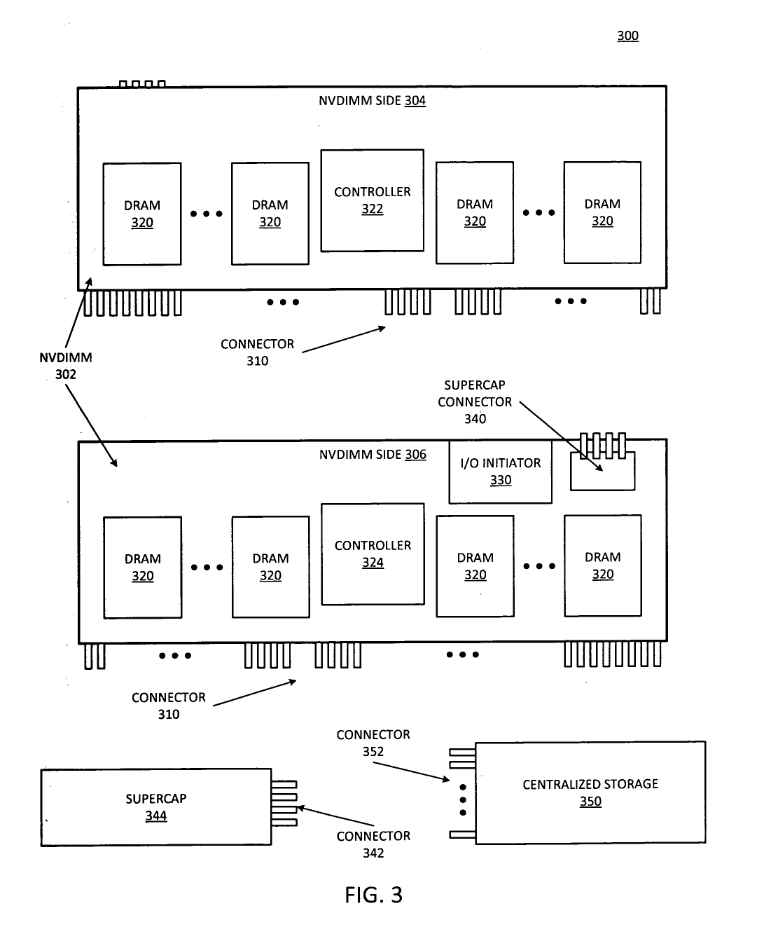

FIG. 3 is a block diagram of an embodiment of a DIMM (dual inline memory module) for a power protected memory system with centralized storage in which data is transferred via device specific self-refresh commands. System 300 provides one example of an NVDIMM in accordance with an embodiment of system 100. In one embodiment, NVDIMM side 304 is a “front” side of NVDIMM 320 and NVDIMM side 306 is a “back” side of NVDIMM 320. Front side 304 is illustrated to include multiple DRAM devices 320. Back side 306 also includes DRAM devices 320, in contrast to traditional protection systems such as illustrated in the configuration of system 200.

NVDIMM 302 can be an LRDIMM (buffers not specifically illustrated) or an RDIMM. By removing the persistent storage from NVDIMM 302 itself, and centralizing the storage device in centralized storage 350, system 300 enables the backing storage media or storage device 350 to be shared across multiple NVDIMMs. It will be understood that centralized storage 350 for backup can be any nonvolatile media. One common medium in use is NAND flash, which can be contained on the platform or stored as a drive in a drive bay, for example.

As shown in system 300, side 306 includes an I/O (input/output) initiator 330, which can represent a microcontroller and/or other logic on NVDIMM 302. In one embodiment, I/O initiator 330 manages I/O to transfer the contents of DRAM devices 320 from NVDIMM 302 to centralized storage 350. Side 306 also illustrates connector 340 to interface with super capacitor 344 to remain powered by the super-cap when power supply power is interrupted.

Connector 310 of NVDIMM 302 represents a connector to enable NVDIMM 302 to connect to a system platform, such as a DIMM slot. In one embodiment, centralized storage 350 includes connector 352, which enables the centralized storage to connect to one or more I/O interfaces or I/O buses that connect to DRAMs 320. More particularly, centralized storage 350 can include interfaces to one or more data buses coupled to DRAMs 320 of NVDIMM 302. Thus, DRAMs 320 can transfer their contents to centralized storage 350 on detection of a power failure. In one embodiment, super-cap 344 includes connector 342 to interface super-cap 344 to connector 340 of NVDIMM 302 and any other PPM (power protected memory) DIMMs in system 300. In one embodiment, I/O initiator 330 is control logic on NVDIMM 302 that coordinates the transfer of data from DRAMs 320 to centralized storage 350 in conjunction with operation by a microcontroller. In one embodiment, I/O initiator 330 is incorporated in one or more controllers 322 or 324.

Controllers 322 and 324 represent examples of logic or circuitry to manage the transfer of data between DRAMs 320 and centralized storage 350. In one embodiment, NVDIMM 302 only includes a single controller 322. In one embodiment, memory devices 320 on front side 304 are controlled by controller 322, and memory devices 320 on back side 306 are controlled by controller 324. Controllers 322 and 324 can represent RCDs. In an embodiment where multiple controllers 322 and 324 are used, each DRAM side can have multiple parallel data paths to centralized storage 350. It will be understood that fewer paths involve less cost and less routing and other hardware, while more paths can increase the bandwidth and/or throughput capacity of NVDIMM 302, such as enabling faster transfer from memory devices 320 in the event of a power failure.

NVDIMM 302 can include multiple parallel data buses as illustrated in system 100. DRAMs 320 share a control line and data bus. DRAMs 320 couple to external centralized storage 350 via at least one data bus, to enable transfer of memory contents to nonvolatile storage. Controllers 322 and/or 324 couple to the control line and shared data bus of DRAMs 320. In one embodiment, controller 322 and/or controller 324 includes logic or circuitry to send device specific self-refresh commands, such as an SRX command, including a command and a device specific identifier. The device specific self-refresh command causes only a specified DRAM 320 to respond to the command, while the other DRAMs ignore the command. System 300 specifically illustrates an embodiment wherein nonvolatile storage is disposed on or located off the NVDIMM. In response to detection of power interruption, in one embodiment, controller 322 and/or controller 324 serially selects DRAMs 320 in turn to transfer data to centralized storage 350. Controller 322 and/or controller 324 can place DRAMs 320 in self-refresh and individually wake them from refresh in turn with device specific refresh commands.

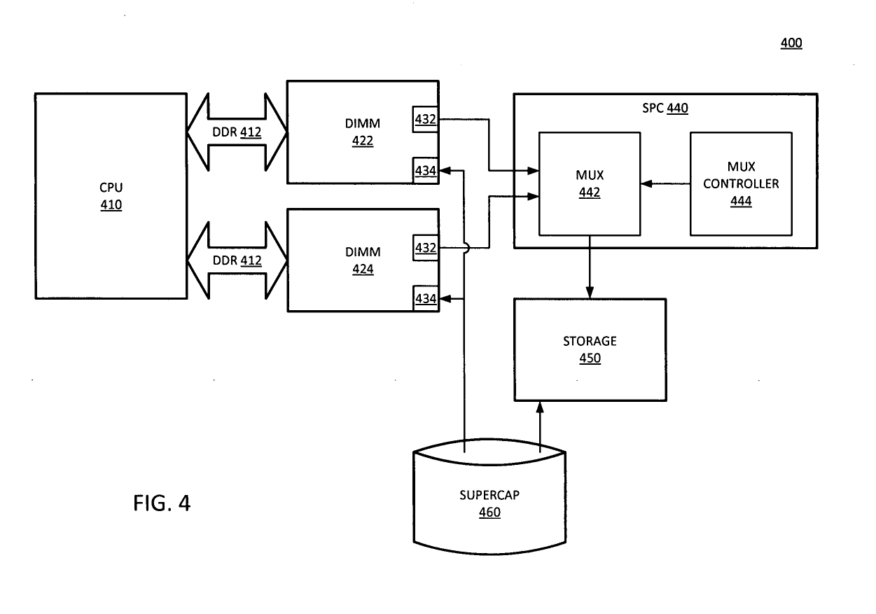

FIG. 4 is a block diagram of an embodiment of a power protected memory system with consolidated storage not on the NVDIMM (nonvolatile DIMM) in which a controller uses device specific self-refresh commands. System 400 provides one example of a system in accordance with system 100, and can use NVDIMMs in accordance with an embodiment of systems 200 and/or 300. System 400 includes centralized or consolidated storage 450. By moving the storage media off the NVDIMM (e.g., DIMMs 422 and 424), multiple NVDIMMs can share storage capacity, which lowers the overall cost of the NVDIMM solution.

In one embodiment, DIMMs 422 and 424 are NVDIMMs, or DIMMs selected for power protection. DIMMs 422 and 424 include SATA ports 432 to couple to mux 442 for transferring contents to storage 450 in the event of a power failure. In one embodiment, SATA ports 432 couple to data buses on the DIMMs that are shared among multiple memory devices in accordance with what is described above. In one embodiment, SATA ports 432 also enable storage 450 to restore the image on DIMMs 422 and 424 when power is restored. In one embodiment, system 400 includes SPC (storage and power controller) 440 to control the copying of contents from NVDIMMs 422 and 424 to storage 450 on power failure, and to control the copying of contents from storage 450 back to NVDIMMs 422 and 424 upon restoration of power. In one embodiment, SPC 440 can represent a storage controller with storage media behind it to act as off-NVDIMM storage.

SPC 440 includes mux controller 444 and mux 442 to provide selective access by the NVDIMMs to storage 450 for purposes of backup and restoration of the backup. In one embodiment, SPC 440 is implemented on DIMMs 422 and 424. In one embodiment, SPC 440 is or includes an RCD or comparable control logic (not specifically shown) to enable the use of device specific self-refresh commands to individual memory devices on DIMMs 422 and 424. It will be understood that the pathway to transfer the data from DIMMs 422 and 424 to storage 450 can be a separate connection than a connection typically used on the platform to access the storage in the event of a page fault at a memory device. In one embodiment, the pathway is a separate, parallel pathway. In one embodiment, the memory can be restored when power is returned via the standard pathway. In one embodiment, the memory is restored from storage by the same pathway used to back the memory up. For example, CPU 410 represents a processor for system 400, which accesses memory of DIMMs 422 and 424 for normal operation via DDR (dual data rate) interfaces 412. Under normal operating conditions, a page fault over DDR 412 would result in CPU 410 accessing data from system nonvolatile storage, which can be the same or different storage from storage 450. The pathway to access the system storage can be the same or different from the pathway from DIMMs 422 and 424 to storage 450 for backup.

System 400 includes super-cap 460 or comparable energy storage device to provide temporary power when system power is lost. Super-cap 460 can be capable of holding an amount of energy that will enable the system to hold a supply voltage at a sufficient level for a sufficient period of time to allow the transfer of contents from the volatile memory on a system power loss condition. The size will thus be dependent on system configuration and system usage. System 400 includes a centralized storage 450, which is powered by super-cap 460 for backup.

In one embodiment, mux 442 of SPC 440 is multiplexing logic to connect multiple different channels of data to storage 450. In one embodiment, the selection of mux 442 operates in parallel to the device specific ID of each memory device, and can thus select each memory device that has been awoken from self-refresh to provide access to the shared data bus for transfer while the other memory devices remain in self-refresh. In one embodiment, mux controller 444 includes a sequencer or sequencing logic that allows multiple DIMMs 422 and 424 to share the storage media. In one embodiment, sequencing logic in an SPC controller ensures that only one DIMM is able to write to the storage media at a given time.

In one embodiment, on system power failure, SPC 440 receives a signal indicating power failure, such as via a SAV signal. In response to the SAV signal or power failure indication, in one embodiment, SPC 440 arbitrates requests from I/O initiator circuitry on the DIMMs to gain access to the storage controller to start a save operation to transfer memory contents to storage 450. In one embodiment, sequencing logic of mux controller 444 provides access to one DIMM at a time. Where arbitration is used, the DIMM that wins arbitration starts its save operation.

In one embodiment, once a DIMM completes its save, it relinquishes access to mux 442, which allows a subsequent DIMM to win its arbitration. Super-cap 460 provides sufficient power to allow all provisioned DIMMs 422 and 424 to complete their save operations. In one embodiment, each DIMM save operation is tagged with metadata that allows SPC 440 to associate the saved image with the corresponding DIMM. In one embodiment, on platform power on, DIMMs 422 and 424 can again arbitrate for access to storage 450 to restore their respective saved images. The flow of transferring the data from DIMMs 422 and 424 can be in accordance with an embodiment of what is described above with respect to system 100. Namely, each memory device of the DIMM can be individually awoken from self-refresh to perform data access over a shared data bus, and then put back into self-refresh. With device specific self-refresh control, the controller can serialize the data from the memory devices to the nonvolatile storage media.

The centralized storage with the controller enables Type 1 compliant NVDIMM (nonvolatile dual inline memory module) designs (energy backed byte accessible persistent memory) with standard DIMM capacity, and reduced footprint on the computing system platform. It will be understood that super capacitor (which may be referred to herein as a “super-cap”) footprint does not increase linearly with increased energy storage capacity. Thus, double the capacitor capacity does not double the capacitor in size. Therefore, a protection system with a centralized larger capacity super-cap can provide an overall reduction in protection system size. Additionally, centralized persistent storage can allow the DIMMs to have standard memory device (such as DRAM (dynamic random access memory)) configurations, which can allow for NVDIMMs that have standard DIMM capacities. In one embodiment, the centralized storage can be implemented in SATA storage that would already be present in the system (e.g., by setting aside a protection partition equal to the size of volatile memory desired to be backed up). The amount of memory to be backed up can then be programmable.

When power supply power goes down or is lost or interrupted, a protection controller can selectively connect the memory portion(s) selected for backup, and transfer their contents while the super-cap charges the memory subsystem (and the storage used for persistent storage of the memory contents) during the data transfer. In one embodiment, the backup storage is a dedicated SATA SSD (solid state storage) on the platform. In one embodiment, the backup storage is part of SATA storage already available on the platform.

In one embodiment, the controller is a controller on each DIMM. In one embodiment, the controller is coupled to a programmable SATA multiplexer, which can selectively connect multiple DRAMs or other memory devices to one or more SATA storage devices (e.g., there can be more than one storage pathway available to transfer data). In one embodiment, the controller couples to each memory device via an I²C (inter-integrated circuit) interface. The controller is coupled to the central super-cap logic to receive indication of when power supply power is interrupted. The controller includes logic to control a programming interface to implement the power protected memory functionality. The programming interface can couple to the memory devices to select them for transfer. In one embodiment, the programming interface enables the controller to cause the memory devices to select a backup port for communication. In one embodiment, the programming interface connects to the programmable SATA multiplexer to select how and when each memory device(s) connect. The controller can be referred to as a PPM-SPC (power protected memory storage and power controller).

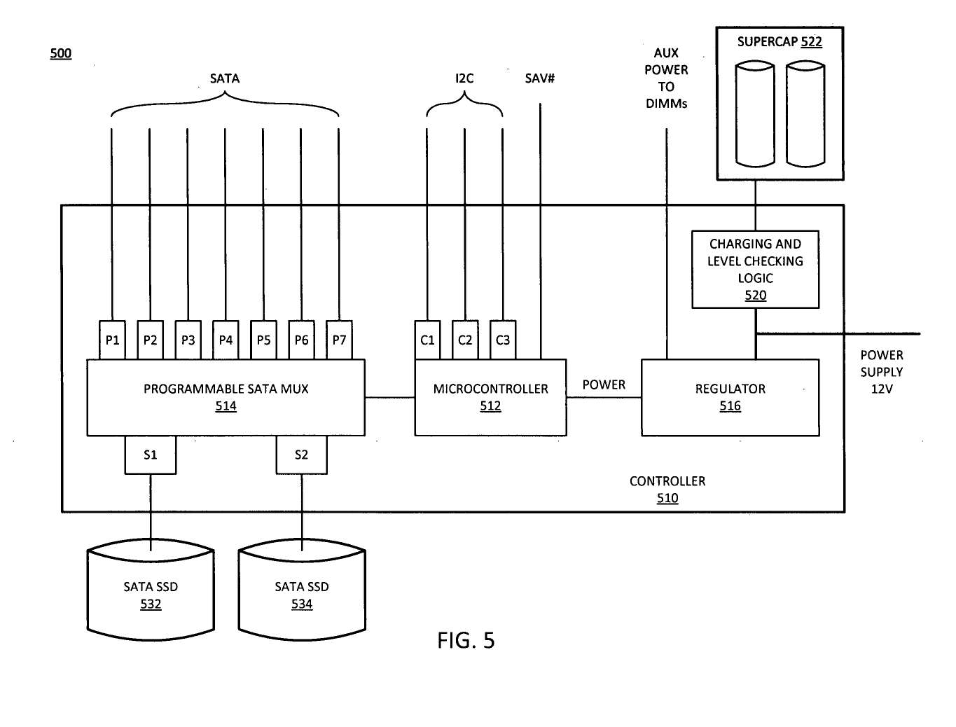

FIG. 5 is a block diagram of an embodiment of a power protected memory system with centralized storage that uses device specific self-refresh commands to perform data transfer. In one embodiment, system 500 illustrates a controller architecture to provide NVDIMM functionality or an equivalent or derivative of NVDIMM. For purposes of simplicity herein, NVDIMM functionality refers to the capability to back up volatile memory devices. Controller 510 represents an SPC or PPM-SPC. In one embodiment, controller 510 implements PDA self-refresh control to individual DRAMs of power protected DIMMs.

In one embodiment, controller 510 includes microcontroller 512, programmable multiplexer (mux) logic 514, super capacitor charging and charging level check logic 520, regulator 516, and I²C controllers or other communication controllers (which can be part of microcontroller 512). System 500 includes centralized super capacitor (super-cap) 522 to provide power when platform power from a power supply is interrupted. The power supply is illustrated as the line coming into controller 510 that is labeled “power supply 12V.” Controller 510 can charge super-cap 522 from the power supply while the power supply power is available. It will be understood that while shown as a 12V power supply, it is one example illustration and the power supply can provide any voltage level appropriate for charging a backup energy source. Logic 520 enables controller 510 to charge super-cap 522 and monitor its charge level. Logic 520 can detect when there is an interruption in power supply power, and allow energy from super-cap 522 to flow to regulator 516. Thus, super-cap 522 provides power in place of the power supply when power is interrupted to system 500.

Regulator 516 can provide power to controller 510 and to the connected DIMMs. Regulator 516 can provide such power based on power supply power when available, and based on energy from super-cap 522 when power supply power is not available, or falls below a threshold input used for regulation. The power supply power is power provided by a hardware platform in which system 500 is incorporated. As illustrated, regulator 516 provides power to microcontroller 512 (and to the rest of controller 510), as well as providing auxiliary power to DIMMs. In one embodiment, the auxiliary power to the DIMMs is only used by the DIMMs when power supply power is interrupted. While not specifically shown in system 500, SATA drives 532 and 534 can likewise be powered from power supply power when available, and are powered from super-cap 522 when power supply power is interrupted. In one embodiment, SATA drives 532 and 534 are charged directly from super-cap 522, and not through regulator 516. In one embodiment, regulator 516 powers the SATA drives.

When the hardware platform in which system 500 is a part provides power via power supply 12V, controller 510 and microcontroller 512 can be powered by the platform. In one embodiment, microcontroller 512 monitors the charging level of super-cap 522. In one embodiment, the platform BIOS (basic input/output system) can check the super capacitor charge level by reading microcontroller 512 through an I²C bus or other suitable communication connection. In one embodiment, the BIOS can check the charging level and report to the host OS (operating system) that controls the platform operation. The BIOS can report to the host OS through an ACPI interface (advanced configuration and power interface) mechanism to indicate to the OS if the NVDIMM has enough charge to save the data on power failure.

In one embodiment, the controller system of system 500 can be implemented in accordance with RCD 110 of system 100. For example, microcontroller 512 can implement the RCD functionality. The SATA muxes 514 can be connected to the RCD to provide access to the SATA SSDs 532 and 534 from the memory devices. Microcontroller 512 can send device specific self-refresh commands in one embodiment.

In one embodiment, the system platform for system 500 provides a power supply monitoring mechanism, by which controller 510 receives an indication of whether the power supply power is available. Microcontroller 512 can control the operation of logic 520 based on whether there is system power. In one embodiment, microcontroller 512 receives a SAV# signal asserted from the host platform when power supply power fails. In one embodiment, if the platform generates a SAV# signal assertion, the PPM DIMMs that receive the signal can enter self-refresh mode. In one embodiment, when controller 510 (e.g., a PPM-SPC) receives the SAV# assertion, microcontroller 512 can select a DIMM port (e.g., P[1:7]) in SATA mux 514. Microcontroller 512 can also inform the selected PPM DIMM through I²C (e.g., C[1:3]) to start saving its memory contents. In one embodiment, controller 510 includes one I²C port per memory channel (e.g., C1, C2, C3). Other configurations are possible with different numbers of I²C ports, different numbers of channels, or a combination. In one embodiment, controller 510 includes a LBA (logical block address) number of an SSD to store to. In one embodiment, the PPM DIMM saves the memory contents to a SATA drive, e.g., SATA SSD 532 or SATA SSD 534, connected to S1 and S2, respectively, of SATA mux 514. In one embodiment, controller 510 polls the PPM DIMM to determine if the transfer is completed.

In one embodiment, programmable SATA mux 514 allows mapping of DIMM channels to SATA drives 532 and 534 in a flexible way. When SATA mux 514 includes flexible mux logic, it can be programmed or configured based on how much data there is to transfer from the volatile memory, and how much time it will take to transfer. Additionally, in one embodiment, controller 512 can control the operation of SATA mux 514 based on how much time is left to transfer (e.g., based on determining the count of a timer started when power supply power was detected as interrupted). Thus, mux 514 can select DIMMs based on how much data there is to transfer and how much time there is to transfer it. As illustrated, SATA mux 514 includes 7 channels. There can be multiple DIMMs per channel. The size of the bus can determine how many devices can transfer concurrently. While SATA storage devices 532 and 534 are illustrated, in general there can be a single storage device, or two or more devices. In one embodiment, SATA storage devices 532 and 534 include storage resources that are dedicated to memory backup, such as configured to be part of a PPM system.

SATA storage devices 532 and 534 include centralized storage resources, rather than a storage resource available for only a single DIMM. Wherever located, multiple DIMMs can store data to the same storage resources in system 500. In one embodiment, SATA storage devices 532 and 534 include storage resources that are part of general purpose storage in the computing system or hardware platform in which system 500 is incorporated. In one embodiment, SATA storage devices 532 and 534 include nonvolatile storage resources built into a memory subsystem. In one embodiment, SATA storage devices 532 and 534 include nonvolatile storage resources outside of the memory subsystem.

Additional flexibility can be provided through the use of device specific self-refresh commands to individual DRAMs or memory devices on a DIMM or other memory module. With device specific commands, system 500 can cause memory devices to exit self-refresh while other devices remain in self-refresh. In addition to controlling data bus collisions, such an operation keeps all memory devices in a low power self-refresh state unless they are transferring data. Thus, the data transfer is more power efficient because only selected memory device(s) will be active at a time. The waking and transfer operations can be in accordance with any embodiment described herein.

Once the transfer is completed from volatile memory to nonvolatile storage, in one embodiment, controller 510 informs the selected power protected DIMM(s) to power down. In one embodiment, only one PPM DIMM is powered up at a time, and controller 510 can select each DIMM in sequence to start saving its contents. The process can continue until PPM DIMM contents are saved. In one embodiment, microcontroller 512 can be programmed during boot which DIMMs to power protect and which DIMMs will not be saved. Thus, system can provide flexibility to allow for optimizing the storage as well as the power and time spent transferring contents. Programming in the host OS can save more critical elements to the DIMMs selected for backup, assuming not all memory resources will be backed up.

As illustrated in system 500, a PPM memory system can include super-cap 522 as a backup energy source coupled in parallel with the platform power supply. Super-cap 522 can provide a temporary source of energy when power from the platform power supply is interrupted. In one embodiment, super-cap 522 is a centralized energy resource, which can provide backup power to multiple DIMMs, instead of being to a single DIMM. System 500 includes one or more SATA storage devices (such as 532 and 534). Controller 510 interfaces with a memory network of volatile memory devices. Controller 510 can detect that the platform power supply is interrupted, which would otherwise power the memory devices. In response to detection of the power interruption, controller 510 can selectively connect the memory devices to storage devices 532 and/or 534 to transfer contents of selected memory devices to the nonvolatile storage.

In one embodiment, SATA mux 514 can enable controller 510 to selectively connect memory devices in turn to SATA storage devices 532 and 534. Thus, for example, each memory device may be provided a window of time dedicated to transferring its contents to the centralized storage. In one embodiment, the order of selection is predetermined based on system configuration. For example, the system can be configured beforehand to identify which memory resources hold the most critical data to back up, and order the backup based on such a configuration. Each memory device may be selectively able to enter and exit self-refresh with device specific commands. Such a configuration allows the host OS to store data in different memory locations based on whether it will be backed up or not.

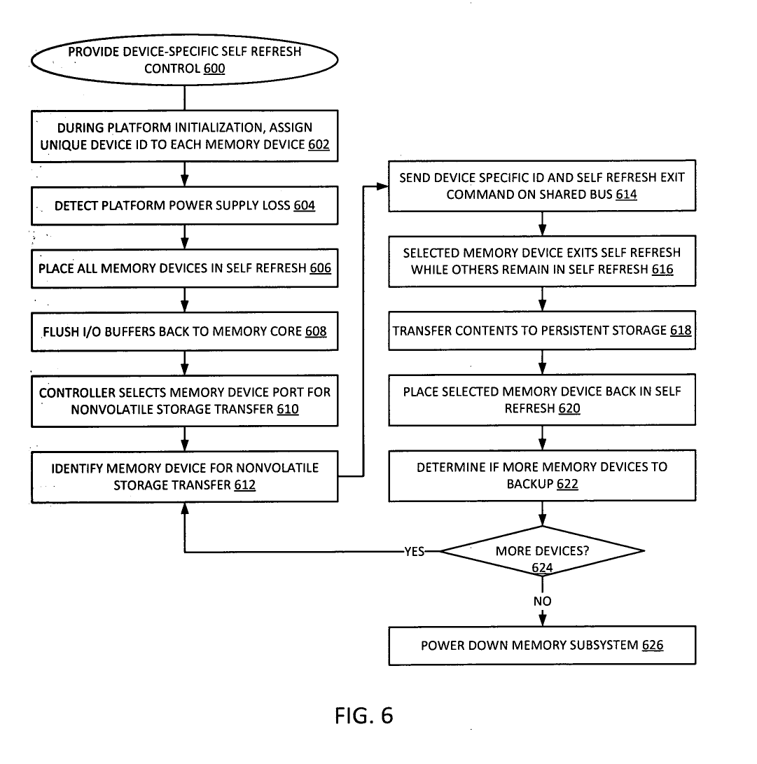

FIG. 6 is a flow diagram of an embodiment of a process for using device specific self-refresh commands for nonvolatile backup of volatile memory. Process 600 illustrates operations for providing device specific self-refresh control, and can be in accordance with embodiments of systems described above. In one embodiment, a system includes an RCD or controller or other control logic to provide device specific commands to the memory devices.

In one embodiment, during initialization of a memory subsystem on a computing platform, a computing platform assigns a unique device ID to memory devices that share a control bus and a data bus, 602. The assignment of the unique device ID enables device specific self-refresh commands to the device. In one embodiment, the unique device ID can be in accordance with an ID assigned for other PDA operations. A computing system detects a loss of system power supplied from a power supply, 604. Without power, the system will shut down. In one embodiment, the loss of system power causes a controller on the computing system platform to initiate a timer and power down platform subsystems. In one embodiment, a controller places all memory devices in self-refresh, 606. In one embodiment, in conjunction with the placing of all memory devices in self-refresh, the controller can place the memory devices in PDA mode. In one embodiment, the system flushes I/O buffers of the memory devices back to the memory core, 608.

In one embodiment, a controller selects a memory device port that has a common data bus connected to the memory devices to use for transferring data from the volatile memory devices to nonvolatile storage, 610. The controller identifies a memory device for nonvolatile storage transfer, 612. The transfer can be to read out data contents in the example illustrated to write to nonvolatile storage, when system power loss is detected. It will be understood that upon detection of restoring system power, a similar process can be executed to write data contents back to the volatile memory device from nonvolatile storage. In one embodiment, the controller selects the memory devices in order of device ID. Other orders can be used. In one embodiment, identifying the memory device for nonvolatile storage transfer can include selecting a subset of memory devices, such as devices on different data buses. In one embodiment, the same controller controls operations on multiple parallel buses. In one embodiment, different controllers control operations on separate parallel buses.

The controller sends a device specific ID and a self-refresh command on a shared bus, 614. The selected memory device identifies its device ID and exits self-refresh, while the other memory devices remain in self-refresh, 616. The controller manages the transfer of data contents between the selected volatile memory device and nonvolatile storage, 618. In one embodiment, when the data access transfer operation(s) are complete, the controller can place the selected memory device back in self-refresh, 620. In one embodiment, placing the selected memory device back in self-refresh includes sending a general self-refresh command to the memory devices. In one embodiment, placing the selected memory device back in self-refresh includes sending a device specific self-refresh entry command to the selected memory device.

When the data access operation transfer is complete, the controller can determine if there are additional memory devices to back up or restore, 622. If there are more devices, 624 YES branch, the controller selects the next memory device and repeats the process. The controller can select through every device to transfer contents in turn. If there are no more devices, 624 NO branch, the controller can power down the memory subsystem in the case of power loss, 626, or restore standard operation in the case of restoring data contents. In one embodiment, the operations of process 600 occur in parallel on parallel data buses.

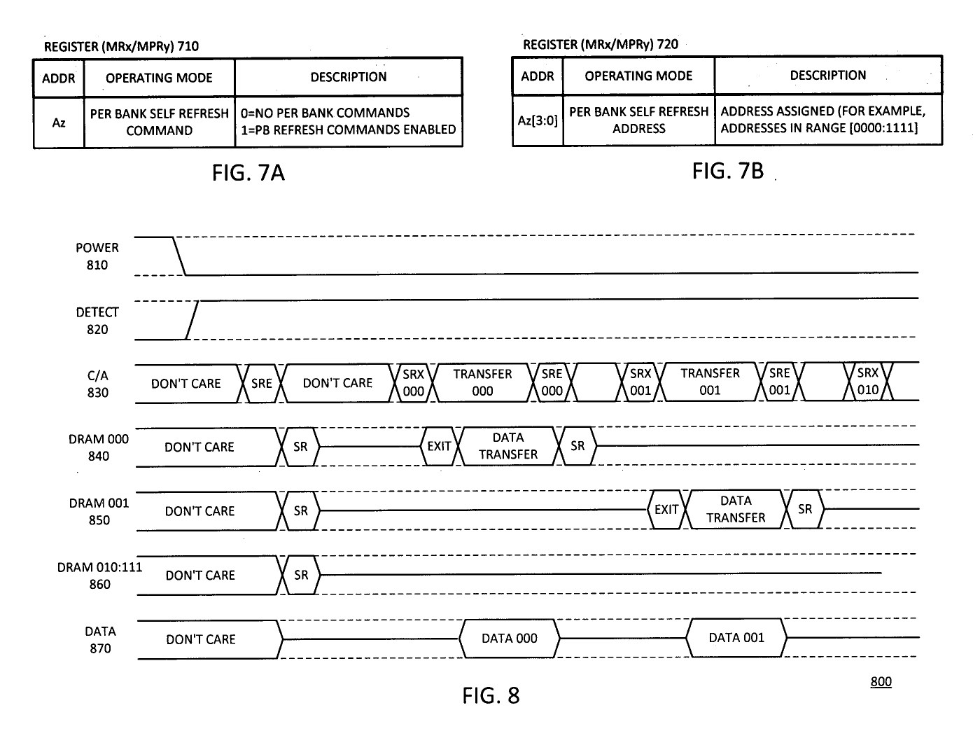

FIG. 7A is a block diagram of an embodiment of a register that enables a per device self-refresh mode. Register 710 illustrates one example of a mode register (MRx) or a multipurpose register (MPRy) to store a setting that enables per bank self-refresh commands. Thus, address Az represents one or more bits to set to enable the per bank self-refresh commands. In one embodiment, Az represents a bit that enables per DRAM addressability (PDA). Thus, a system can leverage existing PDA configuration to also enable PDA mode self-refresh, with different IDs assigned to memory devices that share a data bus and control bus. When not enabled (e.g., Az=0), all memory devices can respond to self-refresh commands. When enabled (e.g., Az=1), only the memory device identified by an ID will respond to the self-refresh command(s), and other memory devices will ignore the commands.

While shown as a register setting, it will be understood that in one embodiment, per device self-refresh can be accomplished with command encoding, such as by providing address information with the command. A self-refresh command (e.g., SRE and SRX for DDR DRAMs) may not include address information. However, a control bit enabled with the self-refresh command can trigger a memory device to decode address information to determine if it is selected for the command or not.

FIG. 7B is a block diagram of an embodiment of a register that stores a per device identifier for per device self-refresh mode. Register 720 illustrates one example of a mode register (MRx) or a multipurpose register (MPRy) to store a device specific ID (DID). The DID can enable per bank self-refresh commands. Thus, address bits for Az (illustrated as bits Az[3:0]) can represent bits to store an address for the memory device. In one embodiment, addresses can be assigned in the range of [0000:1111]. Other numbers of bits and address ranges can be used, depending on the configuration of the system. In one embodiment, a memory device tests a DID received with a self-refresh command against the identifier stored in register 720 to determine whether the self-refresh command applies to the memory device or not. The memory device can ignore commands that have an identifier different from what is stored in register 720.

FIG. 8 is a timing diagram of an embodiment of per device backup to persistent storage. Timing diagram 800 provides one example illustration of a possible flow of operation. Diagram 800 is to be understood as a general example, and is not necessarily representative of a real system. It will also be understood that a clock signal is intentionally left off from diagram 800. The timing diagram is intended to show a relationship between operations, more than specific or relative timing of operations or events. The transfer times will be understood to be much longer than the command timings. Also, it will be understood that data transfers will correspond to commands, which are not specifically shown.

Power signal 810 represents system power to the memory subsystem. At some point in time, power is interrupted, and a detection signal, detect 820, can be triggered. In one embodiment, detect 820 is set as a pulse. In another embodiment, detect 820 can be asserted for as long as the power is interrupted and before the system is powered down. In response to detecting the interruption of power 810, backup power can be provided (not specifically shown).

C/A signal 830 represents a command/address signal line or bus. DRAM 000 signal 840 represents the operation of DRAM 000. DRAM 001 signal 850 represents the operation of DRAM 001. DRAM 010:111 signal 860 represents the operation of other DRAMs 000:111. Data signal 870 represents activity on a data bus shared among DRAMs 000:111. It will be understood that while only 8 DRAMs are represented in diagram 800, more or fewer DRAMs could share a data bus. For all of signals 830, 840, 850, 860, and 870, that state of the signal lines is not considered relevant to the discussion of device specific self-refresh commands, and is illustrated as a Don't Care. There may or may not be activity on the signal lines, but when power 810 is interrupted, the operations will change to a backup state.

In one embodiment, at some point after detect 820 indicates the power loss, a controller (e.g., an RCD or other controller) can send a self-refresh entry (SRE) command to the DRAMs. In response to the SRE command, all DRAMs are illustrated as entering self-refresh, as shown in signals 840, 850, and 860. The controller may or may not perform other backup operations, and the state of the signal line is illustrated as Don't Care. In one embodiment, the controller will wake one DRAM at a time when the memory devices are in self-refresh. For purposes of example, it will be assumed that DRAMs will be caused to exit from self-refresh in order of unique ID.

Thus, in one embodiment, C/A signal 830 includes a self-refresh exit (SRX) command for DRAM 000. In response to the SRX command, DRAM 000 exits self-refresh, as illustrated in signal 840. In response to the SRX command, DRAMs 001:111 remain in self-refresh. With DRAM 000 out of self-refresh, C/A signal 830 provides commands related to data transfer for DRAM 000, and DRAM 000 performs data transfer in response to the commands. In one embodiment, C/A signal 830 illustrates that the controller places DRAM 000 back in self-refresh after the data transfer with SRE (self-refresh entry) command for DRAM 000. In one embodiment, the command is a device specific self-refresh command. In response to the SRE command, DRAM 000 goes back into self-refresh as illustrated in signal 840.

After some period of time, which may be immediately after placing DRAM 000 back in self-refresh, C/A signal illustrates an SRX command for DRAM 001. In response to the command, DRAM 001 exits self-refresh, while DRAMs 000 and 010:111 remain in self-refresh. With DRAM 001 out of self-refresh, C/A signal 830 provides commands related to data transfer for DRAM 001, and DRAM 001 performs data transfer in response to the commands. In one embodiment, C/A signal 830 illustrates that the controller places DRAM 001 back in self-refresh after the data transfer with SRE (self-refresh entry) command for DRAM 001. In response to the SRE command, DRAM 001 goes back into self-refresh as illustrated in signal 850. The process can be repeated for the other DRAMs. It will be seen that shared data bus 870 will first transfer data for DRAM 000, then for DRAM 001, and so forth until all data transfer operations are completed. It will be understood that in this way there are not collisions on the data bus.

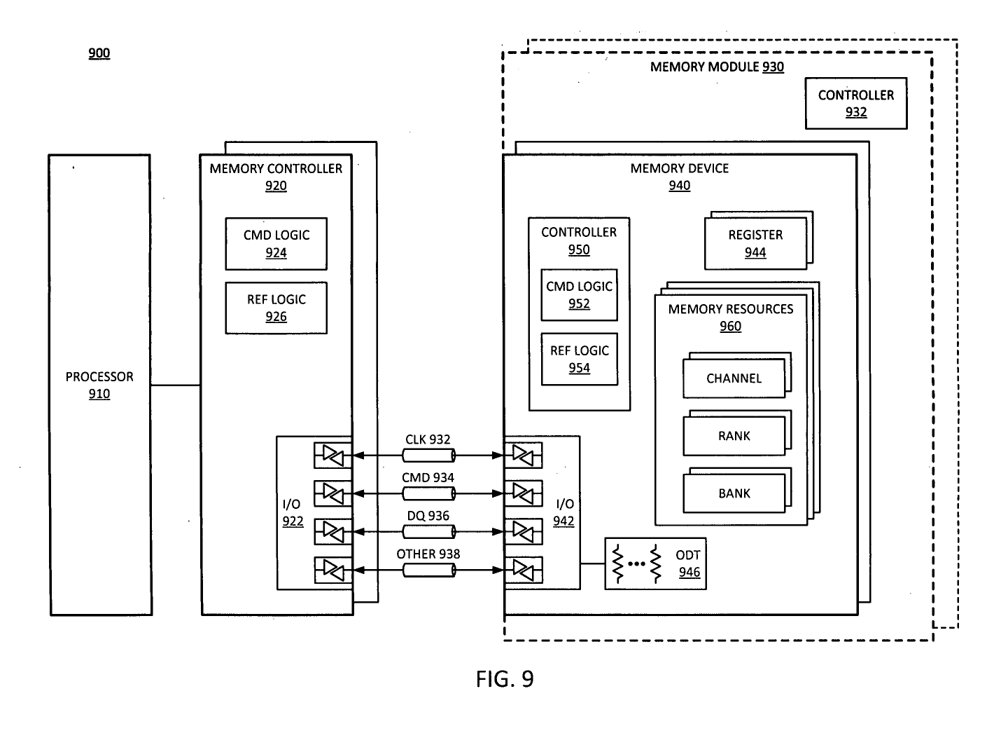

FIG. 9 is a block diagram of an embodiment of a system in which per memory device self-refresh commands can be implemented. System 900 includes elements of a memory subsystem in a computing device. Processor 910 represents a processing unit of a host computing platform that executes an operating system (OS) and applications, which can collectively be referred to as a “host” for the memory. The OS and applications execute operations that result in memory accesses. Processor 910 can include one or more separate processors. Each separate processor can include a single and/or a multicore processing unit. The processing unit can be a primary processor such as a CPU (central processing unit) and/or a peripheral processor such as a GPU (graphics processing unit). System 900 can be implemented as an SOC, or be implemented with standalone components.

Memory controller 920 represents one or more memory controller circuits or devices for system 900. Memory controller 920 represents control logic that generates memory access commands in response to the execution of operations by processor 910. Memory controller 920 accesses one or more memory devices 940. Memory devices 940 can be DRAMs in accordance with any referred to above. In one embodiment, memory devices 940 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. In one embodiment, settings for each channel are controlled by separate mode register or other register settings. In one embodiment, each memory controller 920 manages a separate memory channel, although system 900 can be configured to have multiple channels managed by a single controller, or to have multiple controllers on a single channel. In one embodiment, memory controller 920 is part of host processor 910, such as logic implemented on the same die or implemented in the same package space as the processor.

Memory controller 920 includes I/O interface logic 922 to couple to a system bus. I/O interface logic 922 (as well as I/O 942 of memory device 940) can include pins, connectors, signal lines, and/or other hardware to connect the devices. I/O interface logic 922 can include a hardware interface. As illustrated, I/O interface logic 922 includes at least drivers/transceivers for signal lines. Typically, wires within an integrated circuit interface with a pad or connector to interface to signal lines or traces between devices. I/O interface logic 922 can include drivers, receivers, transceivers, termination, and/or other circuitry to send and/or receive signal on the signal lines between the devices. The system bus can be implemented as multiple signal lines coupling memory controller 920 to memory devices 940. In one embodiment, the system bus includes clock (CLK) 932, command/address (CMD) 934, data (DQ) 936, and other signal lines 938. The signal lines for CMD 934 can be referred to as a “C/A bus” (or ADD/CMD bus, or some other designation indicating the transfer of commands and address information) and the signal lines for DQ 936 be referred to as a “data bus.” In one embodiment, independent channels have different clock signals, C/A buses, data buses, and other signal lines. Thus, system 900 can be considered to have multiple “system buses,” in the sense that an independent interface path can be considered a separate system bus. It will be understood that in addition to the lines explicitly shown, a system bus can include strobe signaling lines, alert lines, auxiliary lines, and other signal lines. In one embodiment, one CMD bus 934 can be shared among devices having multiple DQ buses 936.

It will be understood that the system bus includes a data bus (DQ 936) configured to operate at a bandwidth. Based on design and/or implementation of system 900, DQ 936 can have more or less bandwidth per memory device 940. For example, DQ 936 can support memory devices that have either a x32 interface, a x16 interface, a x8 interface, a x4 interface, or other interface. The convention “xN,” where N is a binary integer refers to an interface size of memory device 940, which represents a number of signal lines DQ 936 that exchange data with memory controller 920. The interface size of the memory devices is a controlling factor on how many memory devices can be used concurrently per channel in system 900 or coupled in parallel to the same signal lines.

Memory devices 940 represent memory resources for system 900. In one embodiment, each memory device 940 is a separate memory die, which can include multiple (e.g., 2) channels per die. Each memory device 940 includes I/O interface logic 942, which has a bandwidth determined by the implementation of the device (e.g., x16 or x8 or some other interface bandwidth), and enables the memory devices to interface with memory controller 920. I/O interface logic 942 can include a hardware interface, and can be in accordance with I/O 922 of memory controller, but at the memory device end. In one embodiment, multiple memory devices 940 are connected in parallel to the same data buses. For example, system 900 can be configured with multiple memory devices 940 coupled in parallel, with each memory device responding to a command, and accessing memory resources 960 internal to each. For a Write operation, an individual memory device 940 can write a portion of the overall data word, and for a Read operation, an individual memory device 940 can fetch a portion of the overall data word.

In one embodiment, memory devices 940 are disposed directly on a motherboard or host system platform (e.g., a PCB (printed circuit board) on which processor 910 is disposed) of a computing device. In one embodiment, memory devices 940 can be organized into memory modules 930. In one embodiment, memory modules 930 represent dual inline memory modules (DIMMs). In one embodiment, memory modules 930 represent other organization of multiple memory devices to share at least a portion of access or control circuitry, which can be a separate circuit, a separate device, or a separate board from the host system platform. Memory modules 930 can include multiple memory devices 940, and the memory modules can include support for multiple separate channels to the included memory devices disposed on them.

Memory devices 940 each include memory resources 960. Memory resources 960 represent individual arrays of memory locations or storage locations for data. Typically memory resources 960 are managed as rows of data, accessed via cacheline (rows) and bitline (individual bits within a row) control. Memory resources 960 can be organized as separate channels, ranks, and banks of memory. Channels are independent control paths to storage locations within memory devices 940. Ranks refer to common locations across multiple memory devices (e.g., same row addresses within different devices). Banks refer to arrays of memory locations within a memory device 940. In one embodiment, banks of memory are divided into sub-banks with at least a portion of shared circuitry for the sub-banks.

In one embodiment, memory devices 940 include one or more registers 944. Registers 944 represent storage devices or storage locations that provide configuration or settings for the operation of the memory device. In one embodiment, registers 944 can provide a storage location for memory device 940 to store data for access by memory controller 920 as part of a control or management operation. In one embodiment, registers 944 include Mode Registers. In one embodiment, registers 944 include multipurpose registers. The configuration of locations within register 944 can configure memory device 940 to operate in different “mode,” where command and/or address information or signal lines can trigger different operations within memory device 940 depending on the mode. Settings of register 944 can indicate configuration for I/O settings (e.g., timing, termination or ODT (on-die termination), driver configuration, self-refresh settings, and/or other I/O settings).

In one embodiment, memory device 940 includes ODT 946 as part of the interface hardware associated with I/O 942. ODT 946 can be configured as mentioned above, and provide settings for impedance to be applied to the interface to specified signal lines. The ODT settings can be changed based on whether a memory device is a selected target of an access operation or a non-target device. ODT 946 settings can affect the timing and reflections of signaling on the terminated lines. Careful control over ODT 946 can enable higher-speed operation with improved matching of applied impedance and loading.

Memory device 940 includes controller 950, which represents control logic within the memory device to control internal operations within the memory device. For example, controller 950 decodes commands sent by memory controller 920 and generates internal operations to execute or satisfy the commands. Controller 950 can be referred to as an internal controller. Controller 950 can determine what mode is selected based on register 944, and configure the access and/or execution of operations for memory resources 960 based on the selected mode. Controller 950 generates control signals to control the routing of bits within memory device 940 to provide a proper interface for the selected mode and direct a command to the proper memory locations or addresses.

Referring again to memory controller 920, memory controller′920 includes command (CMD) logic 924, which represents logic or circuitry to generate commands to send to memory devices 940. Typically, the signaling in memory subsystems includes address information within or accompanying the command to indicate or select one or more memory locations where the memory devices should execute the command. In one embodiment, controller 950 of memory device 940 includes command logic 952 to receive and decode command and address information received via I/O 942 from memory controller 920. Based on the received command and address information, controller 950 can control the timing of operations of the logic and circuitry within memory device 940 to execute the commands. Controller 950 is responsible for compliance with standards or specifications.

In one embodiment, memory controller 920 includes refresh (REF) logic 926. Refresh logic 926 can be used where memory devices 940 are volatile and need to be refreshed to retain a deterministic state. In one embodiment, refresh logic 926 indicates a location for refresh, and a type of refresh to perform. Refresh logic 926 can trigger self-refresh within memory device 940, and/or execute external refreshes by sending refresh commands. For example, in one embodiment, system 900 supports all bank refreshes as well as per bank refreshes, or other all bank and per bank commands. All bank commands cause an operation of a selected bank within all memory devices 940 coupled in parallel. Per bank commands cause the operation of a specified bank within a specified memory device 940. In one embodiment, refresh logic 926 and/or logic in controller 932 on memory module 930 supports the sending of a per device self-refresh exit command. In one embodiment, system 900 support the sending of a per device self-refresh enter command. In one embodiment, controller 950 within memory device 940 includes refresh logic 954 to apply refresh within memory device 940. In one embodiment, refresh logic 954 generates internal operations to perform refresh in accordance with an external refresh received from memory controller 920. Refresh logic 954 can determine if a refresh is directed to memory device 940, and what memory resources 960 to refresh in response to the command.

In one embodiment, memory module 930 includes controller 932, which can represents an RCD or other controller in accordance with an embodiment described herein. In accordance with what is described, system 900 supports an operation where individual memory devices 940 can be selectively caused to enter and exit self-refresh, independent of whether other memory devices 940 are entering or exiting self-refresh. Such operations can enable system 900 to place all memory devices 940 in low power self-refresh state, and individually bring a memory device 940 out of self-refresh to perform access operations, while other memory devices 940 remain in self-refresh. Such operation can be useful to allow memory devices 940 to share a common data bus.

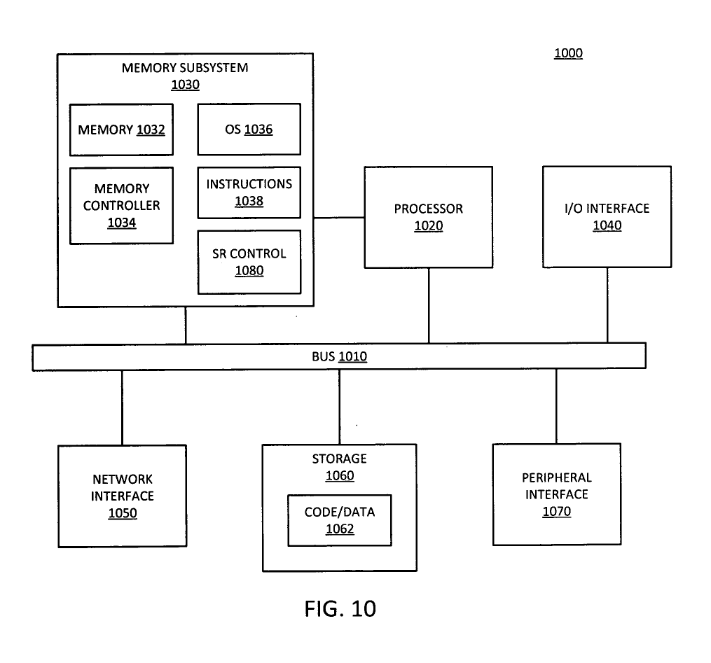

FIG. 10 is a block diagram of an embodiment of a computing system in which a power protected memory system can be implemented. System 1000 represents a computing device in accordance with any embodiment described herein, and can be a laptop computer, a desktop computer, a server, a gaming or entertainment control system, a scanner, copier, printer, routing or switching device, or other electronic device. System 1000 includes processor 1020, which provides processing, operation management, and execution of instructions for system 1000. Processor 1020 can include any type of microprocessor, central processing unit (CPU), processing core, or other processing hardware to provide processing for system 1000. Processor 1020 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Memory subsystem 1030 represents the main memory of system 1000, and provides temporary storage for code to be executed by processor 1020, or data values to be used in executing a routine. Memory subsystem 1030 can include one or more memory devices such as read-only memory (ROM), flash memory, one or more varieties of random access memory (RAM), or other memory devices, or a combination of such devices. Memory subsystem 1030 stores and hosts, among other things, operating system (OS) 1036 to provide a software platform for execution of instructions in system 1000. Additionally, other instructions 1038 are stored and executed from memory subsystem 1030 to provide the logic and the processing of system 1000. OS 1036 and instructions 1038 are executed by processor 1020. Memory subsystem 1030 includes memory device 1032 where it stores data, instructions, programs, or other items. In one embodiment, memory subsystem includes memory controller 1034, which is a memory controller to generate and issue commands to memory device 1032. It will be understood that memory controller 1034 could be a physical part of processor 1020.

Processor 1020 and memory subsystem 1030 are coupled to bus/bus system 1010. Bus 1010 is an abstraction that represents any one or more separate physical buses, communication lines/interfaces, and/or point-to-point connections, connected by appropriate bridges, adapters, and/or controllers. Therefore, bus 1010 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 1010 can also correspond to interfaces in network interface 1050.

System 1000 also includes one or more input/output (I/O) interface(s) 1040, network interface 1050, one or more internal mass storage device(s) 1060, and peripheral interface 1070 coupled to bus 1010. I/O interface 1040 can include one or more interface components through which a user interacts with system 1000 (e.g., video, audio, and/or alphanumeric interfacing). Network interface 1050 provides system 1000 the ability to communicate with remote devices (e.g., servers, other computing devices) over one or more networks. Network interface 1050 can include an Ethernet adapter, wireless interconnection components, USB (universal serial bus), or other wired or wireless standards-based or proprietary interfaces.

Storage 1060 can be or include any conventional medium for storing large amounts of data in a nonvolatile manner, such as one or more magnetic, solid state, or optical based disks, or a combination. Storage 1060 holds code or instructions and data 1062 in a persistent state (i.e., the value is retained despite interruption of power to system 1000). Storage 1060 can be generically considered to be a “memory,” although memory 1030 is the executing or operating memory to provide instructions to processor 1020. Whereas storage 1060 is nonvolatile, memory 1030 can include volatile memory (i.e., the value or state of the data is indeterminate if power is interrupted to system 1000).

Peripheral interface 1070 can include any hardware interface not specifically mentioned above. Peripherals refer generally to devices that connect dependently to system 1000. A dependent connection is one where system 1000 provides the software and/or hardware platform on which operation executes, and with which a user interacts.

In one embodiment, memory subsystem 1030 includes self-refresh (SR) control 1080, which can be control within memory controller 1034 and/or memory 1032 and/or can be control logic on a memory module. SR control 1080 enables system 1000 to individually address specific memory devices 1032 for self-refresh. The device specific SR control enables memory subsystem 1030 to individually address and cause a specific memory device (such as a single DRAM) to enter and/or exit self-refresh. It will be understood that a “single DRAM” can refer to memory resources that are independently addressable to interface with a data bus, and therefore certain memory die can include multiple memory devices. SR control 1080 can enable memory subsystem 1030 to implement an NVDIMM implementation for memory devices that share a control bus and a data bus, in accordance with any embodiment described herein.

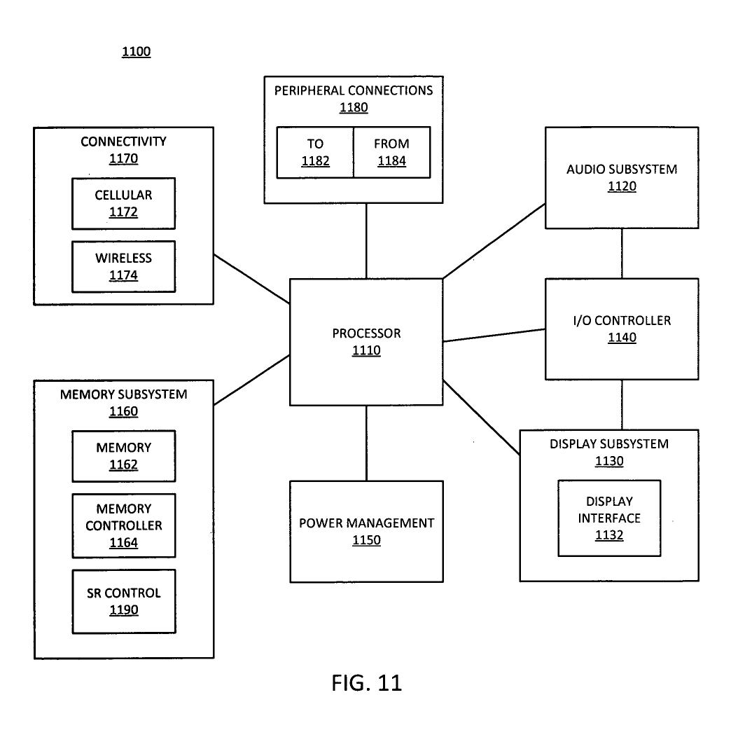

FIG. 11 is a block diagram of an embodiment of a mobile device in which a power protected memory system can be implemented. Device 1100 represents a mobile computing device, such as a computing tablet, a mobile phone or smartphone, a wireless-enabled e-reader, wearable computing device, or other mobile device. It will be understood that certain of the components are shown generally, and not all components of such a device are shown in device 1100.

Device 1100 includes processor 1110, which performs the primary processing operations of device 1100. Processor 1110 can include one or more physical devices, such as microprocessors, application processors, microcontrollers, programmable logic devices, or other processing means. The processing operations performed by processor 1110 include the execution of an operating platform or operating system on which applications and/or device functions are executed. The processing operations include operations related to I/O (input/output) with a human user or with other devices, operations related to power management, and/or operations related to connecting device 1100 to another device. The processing operations can also include operations related to audio I/O and/or display I/O.

In one embodiment, device 1100 includes audio subsystem 1120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 1100, or connected to device 1100. In one embodiment, a user interacts with device 1100 by providing audio commands that are received and processed by processor 1110.

Display subsystem 1130 represents hardware (e.g., display devices) and software (e.g., drivers) components that provide a visual and/or tactile display for a user to interact with the computing device. Display subsystem 1130 includes display interface 1132, which includes the particular screen or hardware device used to provide a display to a user. In one embodiment, display interface 1132 includes logic separate from processor 1110 to perform at least some processing related to the display. In one embodiment, display subsystem 1130 includes a touchscreen device that provides both output and input to a user. In one embodiment, display subsystem 1130 includes a high definition (HD) display that provides an output to a user. High definition can refer to a display having a pixel density of approximately 100 PPI (pixels per inch) or greater, and can include formats such as full HD (e.g., 1080p), retina displays, 4K (ultra high definition or UHD), or others.

I/O controller 1140 represents hardware devices and software components related to interaction with a user. I/O controller 1140 can operate to manage hardware that is part of audio subsystem 1120 and/or display subsystem 1130. Additionally, I/O controller 1140 illustrates a connection point for additional devices that connect to device 1100 through which a user might interact with the system. For example, devices that can be attached to device 1100 might include microphone devices, speaker or stereo systems, video systems or other display device, keyboard or keypad devices, or other I/O devices for use with specific applications such as card readers or other devices.

As mentioned above, I/O controller 1140 can interact with audio subsystem 1120 and/or display subsystem 1130. For example, input through a microphone or other audio device can provide input or commands for one or more applications or functions of device 1100. Additionally, audio output can be provided instead of or in addition to display output. In another example, if display subsystem includes a touchscreen, the display device also acts as an input device, which can be at least partially managed by I/O controller 1140. There can also be additional buttons or switches on device 1100 to provide I/O functions managed by I/O controller 1140.

In one embodiment, I/O controller 1140 manages devices such as accelerometers, cameras, light sensors or other environmental sensors, gyroscopes, global positioning system (GPS), or other hardware that can be included in device 1100. The input can be part of direct user interaction, as well as providing environmental input to the system to influence its operations (such as filtering for noise, adjusting displays for brightness detection, applying a flash for a camera, or other features). In one embodiment, device 1100 includes power management 1150 that manages battery power usage, charging of the battery, and features related to power saving operation.

Memory subsystem 1160 includes memory device(s) 1162 for storing information in device 1100. Memory subsystem 1160 can include nonvolatile (state does not change if power to the memory device is interrupted) and/or volatile (state is indeterminate if power to the memory device is interrupted) memory devices. Memory 1160 can store application data, user data, music, photos, documents, or other data, as well as system data (whether long-term or temporary) related to the execution of the applications and functions of system 1100. In one embodiment, memory subsystem 1160 includes memory controller 1164 (which could also be considered part of the control of system 1100, and could potentially be considered part of processor 1110). Memory controller 1164 includes a scheduler to generate and issue commands to memory device 1162.

Connectivity 1170 includes hardware devices (e.g., wireless and/or wired connectors and communication hardware) and software components (e.g., drivers, protocol stacks) to enable device 1100 to communicate with external devices. The external device could be separate devices, such as other computing devices, wireless access points or base stations, as well as peripherals such as headsets, printers, or other devices.

Connectivity 1170 can include multiple different types of connectivity. To generalize, device 1100 is illustrated with cellular connectivity 1172 and wireless connectivity 1174. Cellular connectivity 1172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 1174 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 1180 include hardware interfaces and connectors, as well as software components (e.g., drivers, protocol stacks) to make peripheral connections. It will be understood that device 1100 could both be a peripheral device (“to” 1182) to other computing devices, as well as have peripheral devices (“from” 1184) connected to it. Device 1100 commonly has a “docking” connector to connect to other computing devices for purposes such as managing (e.g., downloading and/or uploading, changing, synchronizing) content on device 1100. Additionally, a docking connector can allow device 1100 to connect to certain peripherals that allow device 1100 to control content output, for example, to audiovisual or other systems.

In addition to a proprietary docking connector or other proprietary connection hardware, device 1100 can make peripheral connections 1180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

In one embodiment, memory subsystem 1160 includes self-refresh (SR) control 1190, which can be control within memory controller 1164 and/or memory 1162 and/or can be control logic on a memory module. SR control 1190 enables system 1100 to individually address specific memory devices 1162 for self-refresh. The device specific SR control enables memory subsystem 1160 to individually address and cause a specific memory device (such as a single DRAM) to enter and/or exit self-refresh. It will be understood that a “single DRAM” can refer to memory resources that are independently addressable to interface with a data bus, and therefore certain memory die can include multiple memory devices. SR control 1190 can enable memory subsystem 1160 to implement an NVDIMM implementation for memory devices that share a control bus and a data bus, in accordance with any embodiment described herein.

In one aspect, a buffer circuit in a memory subsystem includes: an interface to a control bus, the control bus to be coupled to multiple memory devices; an interface to a data bus, the data bus to be coupled to the multiple memory devices; control logic to send a device specific self-refresh exit command over the control bus when the multiple memory devices are in self-refresh, the command including a unique memory device identifier to cause only an identified memory device to exit self-refresh while the other memory devices remain in self-refresh, and the control logic to perform data access over the data bus for the memory device caused to exit self-refresh.

In one embodiment, the control logic is further to select a subset of the multiple memory devices, and send device specific self-refresh exit commands to each of the selected memory devices of the subset. In one embodiment, the self-refresh exit command includes a CKE (clock enable) signal. In one embodiment, the control logic is further to select the memory devices in turn to cause serial memory access to all of the memory devices. In one embodiment, the buffer circuit comprises a registered clock driver (RCD) of an NVDIMM (nonvolatile dual inline memory module), wherein the control logic is further to transfer self-refresh commands to all memory devices to place the memory devices in self-refresh as part of a backup transfer process to transfer memory contents to a persistent storage upon detection of a power failure. In one embodiment, the interface to the data bus comprises an interface to an alternate data bus parallel to a primary data bus used by the memory devices in active operation, and wherein the control logic is to cause the memory devices to transfer memory contents via the alternate data bus as part of the backup transfer process. In one embodiment, the persistent storage comprises a storage device disposed on the NVDIMM. In one embodiment, the second data bus is to couple to a persistent storage device located external to the NVDIMM. In one embodiment, the buffer circuit comprises a backup controller of a registered DIMM (RDIMM). In one embodiment, after the performance of data access with a selected memory device, the control logic further to send a device specific self-refresh command including a self-refresh enter command and the unique memory device identifier over the control bus to cause the selected memory device to re-enter self-refresh. In one embodiment, the memory devices include dual data rate version 4 synchronous dynamic random access memory devices (DDR4-SDRAMs). In one embodiment, the memory devices are part of a same memory rank, and the control line comprises a command/address bus for the memory rank.

In one aspect, a nonvolatile dual inline memory module (NVDIMM) includes: a first data bus; a second data bus; multiple volatile memory devices coupled to a common control line shared by the memory devices, the memory devices further to couple to a nonvolatile storage via the second data bus; and control logic coupled to the memory devices via the first data bus and via the common control line, the control logic including control logic to send a device specific self-refresh exit command over the control line when the multiple memory devices are in self-refresh, the command including a unique memory device identifier to cause only an identified memory device to exit self-refresh while the other memory devices remain in self-refresh, and the control logic to cause the identified memory device to transfer memory contents via the second memory bus while the other memory devices remain in self-refresh.

In one embodiment, the memory devices include dual data rate version 4 synchronous dynamic random access memory devices (DDR4-SDRAMs). In one embodiment, the nonvolatile storage comprises a storage device disposed on the NVDIMM. In one embodiment, the second data bus is to couple to a nonvolatile storage device located external to the NVDIMM. In one embodiment, the control logic is further to selectively cause one memory device at a time to exit self-refresh, transfer memory contents to the nonvolatile storage, and then return to self-refresh, repeating for all memory devices in turn in response to detection of a power failure. In one embodiment, after the performance of data access with a selected memory device, the control logic further to send a device specific self-refresh command including a self-refresh enter command and the unique memory device identifier over the control bus to cause the selected memory device to re-enter self-refresh. In one embodiment, the memory devices are part of a same memory rank, and the control line comprises a command/address bus for the memory rank. In one embodiment, the control logic comprises a registered clock driver (RCD). In one embodiment, the buffer circuit comprises a backup controller of a registered DIMM (RDIMM). In one embodiment, the control logic is further to select a subset of the multiple memory devices, and send device specific self-refresh exit commands to each of the selected memory devices of the subset. In one embodiment, the self-refresh exit command includes a CKE (clock enable) signal.

In one aspect, a method for memory management includes: selecting for data access one of multiple memory devices that share a control bus, wherein the memory devices are in self-refresh; sending a device specific self-refresh exit command including a self-refresh exit command and a unique memory device identifier over the shared control bus to cause only the selected memory device to exit self-refresh while the others remain in self-refresh; and performing data access over a shared data bus for the memory device not in self-refresh.

In one embodiment, selecting comprises selecting a subset of memory devices, and sending the device specific self-refresh exit command comprises sending device specific commands to each memory device of the selected subset. In one embodiment, selecting comprises selecting each memory device individually to cause serial memory access to the memory devices. In one embodiment, sending the self-refresh exit command comprises sending a CKE (clock enable) signal. In one embodiment, the memory devices comprise memory devices of a registered DIMM (RDIMM). In one embodiment, further comprising: after performing the data access with the selected memory device, sending a device specific self-refresh command including a self-refresh command and the unique memory device identifier over the shared control bus to cause the selected memory device to re-enter self-refresh. In one embodiment, the sending the device specific self-refresh command comprises sending a command from a registered clock driver (RCD) of an NVDIMM (nonvolatile dual inline memory module). In one embodiment, performing data access further comprises transferring data contents as part of a backup transfer process to transfer memory contents to a persistent storage upon detection of a power failure. In one embodiment, performing the data access further comprises performing the data access on an alternate data bus parallel to a primary data bus, wherein the primary data bus to is be used by the memory devices in active operation, and wherein the alternate data bus is to be used by the memory devices as part of the backup transfer process. In one embodiment, the persistent storage comprises a storage device disposed on the NVDIMM. In one embodiment, the persistent storage comprises a storage device located external to the NVDIMM. In one embodiment, the memory devices share the control bus as part of a memory rank that shares a command/address bus. In one embodiment, the memory devices include dual data rate version 4 synchronous dynamic random access memory devices (DDR4-SDRAMs).

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A buffer circuit in a memory subsystem, comprising:
an interface to a control bus, the control bus to be coupled to multiple memory devices;
an interface to a data bus, the data bus to be coupled to the multiple memory devices;
control logic to send a device specific self-refresh exit command over the control bus when the multiple memory devices are in self-refresh, the command including a unique memory device identifier to cause only an identified memory device to exit self-refresh while the other memory devices remain in self-refresh, and the control logic to perform data access over the data bus for the memory device caused to exit self-refresh.

2. The buffer circuit of claim 1, wherein the control logic is further to select a subset of the multiple memory devices, and send device specific self-refresh exit commands to each of the selected memory devices of the subset.

3. The buffer circuit of claim 1, wherein the self-refresh exit command includes a CKE (clock enable) signal.

4. The buffer circuit of claim 1, wherein the control logic is further to select the memory devices in turn to cause serial memory access to all of the memory devices.

5. The buffer circuit of claim 1, wherein the buffer circuit comprises a registered clock driver (RCD) of an NVDIMM (nonvolatile dual inline memory module), wherein the control logic is further to transfer self-refresh commands to all memory devices to place the memory devices in self-refresh as part of a backup transfer process to transfer memory contents to a persistent storage upon detection of a power failure.

6. The buffer circuit of claim 5, wherein the interface to the data bus comprises an interface to an alternate data bus parallel to a primary data bus used by the memory devices in active operation, and wherein the control logic is to cause the memory devices to transfer memory contents via the alternate data bus as part of the backup transfer process.

7. The buffer circuit of claim 1, wherein the buffer circuit comprises a backup controller of a registered DIMM (RDIMM).

8. The buffer circuit of claim 1, wherein after the performance of data access with a selected memory device, the control logic further to send a device specific self-refresh command including a self-refresh enter command and the unique memory device identifier over the control bus to cause the selected memory device to re-enter self-refresh.

9. The buffer circuit of claim 1, wherein the memory devices share the control bus as part of a memory rank that shares a command/address bus.

10. A nonvolatile dual inline memory module (NVDIMM), comprising:
a first data bus;
a second data bus;
multiple volatile memory devices coupled to a common control line shared by the memory devices, the memory devices further to couple to a nonvolatile storage via the second data bus; and
control logic coupled to the memory devices via the first data bus and via the common control line, the control logic including control logic to send a device specific self-refresh exit command over the control line when the multiple memory devices are in self-refresh, the command including a unique memory device identifier to cause only an identified memory device to exit self-refresh while the other memory devices remain in self-refresh, and the control logic to cause the identified memory device to transfer memory contents via the second memory bus while the other memory devices remain in self-refresh.

11. The NVDIMM of claim 10, wherein the memory devices include dual data rate version 4 synchronous dynamic random access memory devices (DDR4-SDRAMs).

12. The NVDIMM of claim 10, wherein the nonvolatile storage comprises a storage device disposed on the NVDIMM.

13. The NVDIMM of claim 10, wherein the second data bus is to couple to a nonvolatile storage device located external to the NVDIMM.

14. The NVDIMM of claim 10, wherein the control logic is further to selectively cause one memory device at a time to exit self-refresh, transfer memory contents to the nonvolatile storage, and then return to self-refresh, repeating for all memory devices in turn in response to detection of a power failure.

15. The NVDIMM of claim 10, wherein the memory devices are part of a same memory rank, and the control line comprises a command/address bus for the memory rank.

16. The NVDIMM of claim 10, wherein the control logic comprises a registered clock driver (RCD).

17. A method memory management, comprising:
selecting for data access one of multiple memory devices that share a control bus, wherein the memory devices are in self-refresh;
sending a device specific self-refresh exit command including a self-refresh exit command and a unique memory device identifier over the shared control bus to cause only the selected memory device to exit self-refresh while the others remain in self-refresh; and
performing data access over a shared data bus for the memory device not in self-refresh.

18. The method of claim 17, wherein selecting comprises selecting a subset of memory devices, and sending the device specific self-refresh exit command comprises sending device specific commands to each memory device of the selected subset.

19. The method of claim 17, wherein selecting comprises selecting each memory device individually to cause serial memory access to the memory devices.

20. The method of claim 17, wherein the memory devices comprise memory devices of a registered DIMM (RDIMM).

21. The method of claim 17, further comprising:
after performing the data access with the selected memory device, sending a device specific self-refresh command including a self-refresh command and the unique memory device identifier over the shared control bus to cause the selected memory device to re-enter self-refresh.
